(19) United States
(12) Patent Application Publication
(10) Pub. No.: US 2025/0316430 A1
(43) Pub. Date: Oct. 9, 2025

(54) PROTECTION DEVICE

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Takuya KOBAYASHI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/867,880

(22) PCT Filed: May 31, 2022
(86) PCT No.: PCT/JP2022/022093

§ 371 Date: Nov. 21, 2024

(51) Int. Cl. H01H 39/00

(52) U.S. Cl. CPC H01H 39/006

(57) ABSTRACT

To protect a circuit from a surge voltage while allowing the circuit to be downsized, a protection device is used in an interruption system including: a first circuit including a first power path and a second power path, which are paths through which electric power is transmitted; an interrupter including an interruption unit provided so as to be able to interrupt the second power path, and a metal housing accommodating at least a portion of the interruption unit; and a second circuit that provides an interruption signal to the interruption unit. The protection device includes a conductive portion serving as a conductive path between a target section including a ground portion and the metal housing.

### CROSS-REFERENCE TO RELATED APPLICATIONS

This application is the U.S. national stage of PCT/JP2022/022093 filed on May 31, 2022, the contents of which is incorporated herein.

### TECHNICAL FIELD

The present disclosure relates to a protection device.

### BACKGROUND

JP 62-021322A discloses a drive circuit that drives a power MOSFET via a pulse transformer. This circuit is configured such that a power MOSFET side and a drive side to which a PWM signal that controls the power MOSFET is input are separated by the pulse transformer. With this configuration, even if a surge voltage occurs on the power MOSFET side, the pulse transformer can prevent the surge voltage from entering the drive side.

The circuit disclosed in JP 62-021322A uses a pulse transformer, and therefore it is difficult to downsize the circuit. For this reason, there is a need for a technique that can prevent a surge voltage from entering the drive side while allowing the circuit to be downsized.

The present disclosure has been made in view of the above-described circumstances and aims to provide a protection device that protects a circuit from a surge voltage while allowing the circuit to be downsized.

### SUMMARY

A protection device according to the present disclosure is a protection device to be used in an interruption system including: a first circuit including a power path that is a path through which electric power is transmitted; an interrupter including an interruption unit provided so as to be able to interrupt the power path, and a metal housing accommodating at least a portion of the interruption unit; and a second circuit that provides an interruption signal to the interruption unit, wherein the protection device includes a protection path section including a conductive portion serving as a conductive path between a target section including either the first circuit or the ground portion and the metal housing, or a parasitic capacitance section generating a parasitic capacitance larger than a parasitic capacitance between the metal housing and the second circuit.

### ADVANTAGEOUS EFFECTS

According to the present disclosure, it is possible to protect a circuit from a surge voltage while at the same time miniaturizing the circuit.

### BRIEF DESCRIPTION OF DRAWINGS

FIG. 1 is a block diagram illustrating an on-board system according to a first embodiment.

FIG. 2 is a block diagram illustrating details of an interrupter according to the first embodiment.

FIG. 3 is a block diagram illustrating details of an interrupter according to a second embodiment.

FIG. 4 is a block diagram illustrating details of an interrupter according to a third embodiment.

FIG. 5 is a block diagram illustrating details of an interrupter according to a fourth embodiment.

FIG. 6 is a block diagram illustrating details of an interrupter according to another embodiment.

### DETAILED DESCRIPTION OF PREFERRED EMBODIMENTS

First, aspects of the present disclosure will be listed and described.

In a first aspect, a protection device according to the present disclosure is used in an interruption system including a first circuit, an interrupter, and a second circuit. The first circuit includes a power path that is a path through which electric power is transmitted. The interrupter includes an interruption unit provided so as to be able to interrupt the power path, and a metal housing accommodating at least a portion of the interruption unit. The second circuit provides an interruption signal to the interruption unit. This protection device includes a protection path section including a conductive portion serving as a conductive path between a target section including either the first circuit or the ground portion and the metal housing, or a parasitic capacitance section generating a parasitic capacitance larger than a parasitic capacitance between the metal housing and the second circuit.

With the protection device according to the first aspect, even if the distribution of electric charges within the metal housing is biased by a surge voltage generated in the first circuit, the protection path section can quickly release the bias of the electric charge distribution within the metal housing to the target section, thereby eliminating the biased distribution. Therefore, it is possible to prevent a surge voltage occurring in the first circuit from affecting the second circuit via the metal housing while allowing the circuit to be downsized.

In a second aspect, in the protection device according to the first aspect, the protection path section may include the conductive portion, and the conductive portion may short circuit the metal housing and the target section.

In the protection device according to the second aspect, the conductive portion allows electric charges to move between the metal housing and the target section, and therefore the bias of the electric charge distribution within the metal housing can be easily released to the target section.

In a third aspect, in the protection device according to the second aspect, the target section may include the ground portion, and the protection path section may constitute the conductive path between the metal housing and the ground portion.

The protection device according to the third aspect can easily stabilize the potential of the metal housing.

In a fourth aspect, in any of the first through the third aspects, the power path may include a high-potential conductive path provided on a high-potential side with respect to the interrupter and a low-potential conductive path provided on a low-potential side with respect to the interrupter. The interrupter may be provided so as to be able to disconnect the high-potential conductive path and the low-potential conductive path, and the target section may include the low-potential conductive path.

With the protection device according to the fourth aspect, even if the distribution of electric charges within the metal housing is biased by a surge voltage occurring due to the inductance component of the high-potential conductive path, the bias of the electric charge distribution can be eliminated between the metal housing and the low-potential conductive path within the first circuit. Therefore, it is possible to prevent the surge voltage from affecting the second circuit.

In a fifth aspect, in any of the first through the third aspects, the power path may include a high-potential conductive path provided on a high-potential side with respect to the interrupter and a low-potential conductive path provided on a low-potential side with respect to the interrupter. The interrupter may be provided so as to be able to disconnect the high-potential conductive path and the low-potential conductive path, and the target section may include the high-potential conductive path.

With the protection device according to the fifth aspect, even if the distribution of electric charges within the metal housing is biased by a surge voltage occurring due to the inductance component of the low-potential conductive path, the bias of the electric charge distribution can be eliminated between the metal housing and the high-potential conductive path within the first circuit. Therefore, it is possible to prevent the surge voltage from affecting the second circuit.

In a sixth aspect according to the first aspect, the second circuit may include a reference conductive path that is the ground portion, and a second conductive path that is a conductive path different from the reference conductive path. The target section may include the reference conductive path. A second parasitic capacitance that is a parasitic capacitance between the metal housing and the reference conductive path may be larger than a first parasitic capacitance that is a parasitic capacitance between the metal housing and the second conductive path.

With the protection device according to the sixth aspect, when the distribution of electric charges within the metal housing is biased by a surge voltage generated in the first circuit, the second parasitic capacitance, which is larger than the first parasitic capacitance, can more easily cancel the bias of the electric charge distribution. Therefore, it is possible to make the surge voltage generated in the first circuit less likely to affect the second circuit via the metal housing.

In a seventh aspect, in the protection device according to any of the first through the sixth aspects, the interruption unit may include an igniter that performs an explosion operation in response to the interruption signal, a cutting target section that is provided on the power path and interrupts the power path when the cutting target section itself is cut, and a displacement section that is displaced by a force generated by the explosion operation. The interruption unit may be a fuse device that cuts the cutting target section by displacement of the displacement section that occurs in response to the explosion operation.

In the protection device according to the seventh aspect, the displacement section is rapidly displaced by the force generated by the explosion operation of the igniter, so that the power path can be interrupted in an extremely short time.

### First Embodiment

### Overview of Interruption System

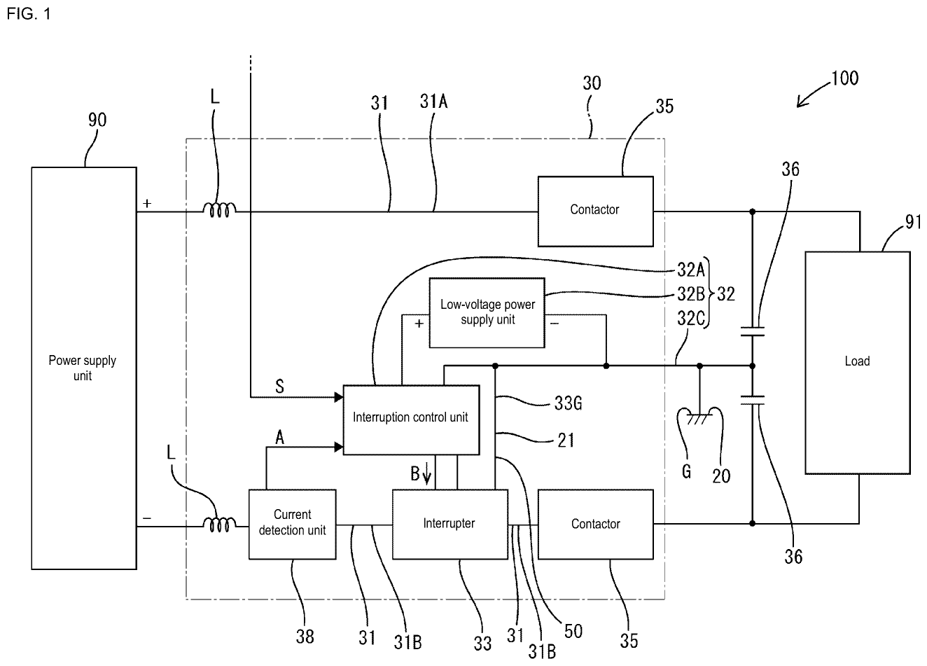

An on-board system 100 shown in FIG. 1 is a system to be installed in a vehicle. The on-board system 100 includes a power supply unit 90, a load 91, and an interruption system 30. For example, a lead-acid battery or a lithium-ion battery is used as the power supply unit 90. The load 91 is an electronic device provided in the vehicle.

The interruption system 30 includes a first circuit 31, a second circuit 32, an interrupter 33, and a protection device 50. The first circuit 31 includes a first power path 31A, which is a power path electrically connected to the high-potential terminal of the power supply unit 90, and a second power path 31B, which is a power path electrically connected to the low-potential terminal of the power supply unit 90. The first power path 31A and the second power path 31B are paths through which electric power is transmitted. The first power path 31A and the second power path 31B are each provided with a contactor 35 interposed therein. The contactors 35 have the function of switching the first power path 31A and the second power path 31B to a conductive state and a non-conductive state. The first power path 31A and the second power path 31B each have an inductance component L. The inductance component L is a parasitic component that each of the first power path 31A and the second power path 31B has.

In each of the first power path 31A and the second power path 31B, a capacitor 36 is electrically connected to a position on the load 91 side with respect to the contactor 35 thereof. The first power path 31A and the second power path 31B are each electrically connected to a ground portion G via the capacitor 36 thereof and a reference conductive path 32C, which will be described later. The ground portion G is, for example, a chassis that is included in the body of the vehicle. The ground portion G is included in the components of a target section 20.

In the present disclosure, the term “electrically connected” preferably means a configuration in which connection targets are connected in a mutually conductive state (a state in which a current can flow) such that the potentials of the two connection targets are equal. However, the term is not limited to this configuration. For example, “electrically connected” may mean a configuration in which the two connection targets are connected in a state in which they can be electrically connected to each other with an electric component interposed therebetween.

In the second power path 31B, a current detection unit 38 is provided on the power supply unit 90 side with respect to the contactor 35. The current detection unit 38 includes, for example, a resistor and a differential amplifier, and is configured to output a value indicating the current flowing through the second power path 31B (specifically, an analog voltage corresponding to the value of the current flowing through the second power path 31B) as a current value A. The current detection unit 38 detects the state of the current flowing through the second power path 31B.

The second circuit 32 includes an interruption control unit 32A, a low-voltage power supply unit 32B, and a reference conductive path 32C. The interruption control unit 32A is mainly constituted by, for example, a microcomputer, and includes an arithmetic unit such as a CPU (Central Processing Unit), memories such as a ROM (Read Only Memory) and a RAM (Random Access Memory), an A/D converter, and so on. The interruption control unit 32A is configured so that the current value A output from the current detection unit 38 is input thereto. The interruption control unit 32A is also configured so that a signal S (SOC (State Of Charge) or the like) indicating the state of the power supply unit 90 from an external device such as a battery management system (BMS) (not shown) can be input thereto. The interruption control unit 32A of the second circuit 32 is configured to provide an interruption signal B to an igniter 33C of an interruption unit 33A of the interrupter 33, which will be described later, based on the current value A or the signal S input from the current detection unit 38 or an external device.

For example, a lead-acid battery or a lithium-ion battery is used as the low-voltage power supply unit 32B. The voltage generated between the high-potential terminal and the low-potential terminal of the low-voltage power supply unit 32B is lower than the voltage of the power supply unit 90. The low-voltage power supply unit 32B is configured to be able to supply power to the interruption control unit 32A.

The reference conductive path 32C is a conductive path maintained at a constant low voltage in the second circuit 32 and is electrically connected to the ground portion G in the first embodiment. The low-potential terminal of the low-voltage power supply unit 32B and the interruption control unit 32A are electrically connected to the reference conductive path 32C. The reference conductive path 32C also serves as the ground portion G.

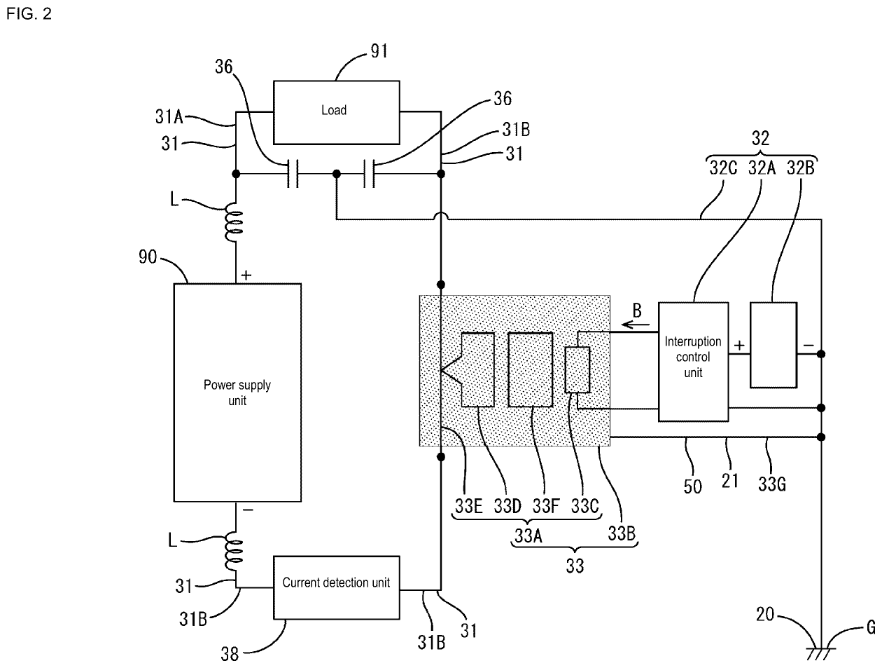

For example, PYROFUSE (registered trademark) is used as the interrupter 33. As shown in FIG. 2, the interrupter 33 includes an interruption unit 33A and a metal housing 33B. The interruption unit 33A includes an igniter 33C, an explosive material 33F, a displacement section 33D, and a cutting target section 33E.

The igniter 33C is configured to generate heat when the interruption signal B is provided from the interruption control unit 32A. The explosive material 33F is provided adjacent to the igniter 33C. The explosive material 33F explodes and generates an explosive force when receiving heat generated by the igniter 33C. That is to say, the igniter 33C performs an explosion operation to ignite the explosive material 33F in response to the interruption signal B. The displacement section 33D is provided adjacent to the explosive material 33F. The displacement section 33D is rapidly displaced when subjected to the explosive force generated by the exploded explosive material 33F.

The cutting target section 33E is made of, for example, a strip-shaped conductive metal. The cutting target section 33E is interposed in the second power path 31B. That is to say, the cutting target section 33E is provided on a power path. The cutting target section 33E is disposed on the opposite side of the explosive material 33F with respect to the displacement section 33D. The cutting target section 33E is physically cut in an extremely short time by the displacement section 33D, which is rapidly displaced by the explosive force generated by the explosion operation. Thus, the cutting target section 33E interrupts the second power path 31B, which is a power path, when the cutting target section 33E itself is cut. In this way, the interruption unit 33A interrupts the second power path 31B, which is a power path. That is to say, the interruption unit 33A is configured to interrupt the second power path 31B. The cutting target section 33E that has been cut will not be reconnected. That is to say, the second power path 31B that has been interrupted by the interruption unit 33A will not be switched to a conductive state that allows a current to flow. In other words, the interruption unit 33A is a fuse device that cuts the cutting target section 33E as a result of the displacement of the displacement section 33D that occurs in response to the explosion operation.

The metal housing 33B is a box-shaped housing formed by pressing a metal plate, for example. The metal housing 33B accommodates the interruption unit 33A. For example, both ends of the cutting target section 33E protrude outward from the metal housing 33B. That is to say, the metal housing 33B accommodates a portion of the interruption unit 33A.

The protection device 50 is used in the interruption system 30. The protection device 50 includes a protection path section 21. The protection path section 21 includes a conductive portion 33G. The conductive portion 33G is made of a conductive metal. One end of the conductive portion 33G is electrically connected to the metal housing 33B. The other end of the conductive portion 33G is electrically connected to the reference conductive path 32C. The conductive portion 33G is interposed between the metal housing 33B and the ground portion G. That is to say, the metal housing 33B is electrically connected to the ground portion G via the conductive portion 33G and the reference conductive path 32C. The conductive portion 33G electrically connects the metal housing 33B and the ground portion G to each other, thereby short-circuiting them. That is to say, the conductive portion 33G of the protection path section 21 constitutes a conductive path between the ground portion G of the target section 20 and the metal housing 33B. The protection path section 21 functions to release electric charge to the ground portion G via itself when a surge voltage is applied to the metal housing 33B.

### Operation of Interruption System

The interruption control unit 32A outputs the interruption signal B to the igniter 33C of the interruption unit 33A of the interrupter 33 based on a signal input from the current detection unit 38 or an external device. As a result, the igniter 33C of the interruption unit 33A generates heat, and the explosive material 33F explodes due to this heat. When the explosive material 33F explodes, the displacement section 33D is rapidly displaced, and the cutting target section 33E is cut. As a result, the current flowing through the second power path 31B quickly stops. With this change in the current flow, a surge voltage is generated on one end side or the other end side of the cutting target section 33E due to the inductance component L of the first circuit 31.

The distribution of electric charges within the metal housing 33B is biased due to induction by the surge voltage. The metal housing 33B is electrically connected to the ground portion G by the conductive portion 33G. Therefore, even if the distribution of electric charges within the metal housing 33B is biased, electric charges are immediately exchanged with the ground portion G, thereby preventing the surge voltage from affecting the interruption control unit 32A of the second circuit 32 via the metal housing 33B.

Next, the effects of this configuration will be illustrated.

A protection device 50 is used in an interruption system 30 including a first circuit 31, an interrupter 33, and a second circuit 32. The first circuit 31 includes a first power path 31A and a second power path 31B, which are paths through which electric power is transmitted. The interrupter 33 includes an interruption unit 33A configured to interrupt the second power path 31B, and a metal housing 33B accommodating at least a portion of the interruption unit 33A. The second circuit 32 provides an interruption signal B to the interruption unit 33A. The protection device 50 includes a protection path section 21 including a conductive portion 33G serving as a conductive path between a target section 20, which includes a ground portion G, and the metal housing 33B. With this configuration, even if the distribution of electric charges within the metal housing 33B is biased by a surge voltage occurring in the first circuit 31, the conductive portion 33G of the protection path section 21 can quickly diffuse the bias of the electric charge distribution within the metal housing 33B to the ground portion G of the target section 20, thereby eliminating the biased distribution. Therefore, it is possible to prevent a surge voltage occurring in the first circuit 31 from affecting the second circuit 32 via the metal housing 33B while allowing the circuit to be downsized.

In the protection device 50, the protection path section 21 includes a conductive portion 33G, and the conductive portion 33G short-circuits the metal housing 33B and the ground portion G of the target section 20. With this configuration, the conductive portion 33G allows electric charges to move between the metal housing 33B and the ground portion G of the target section 20, so that the bias of the electric charge distribution within the metal housing 33B can be easily released to the ground portion G of the target section 20.

In the protection device 50, the target section 20 includes the ground portion G, and the conductive portion 33G of the protection path section 21 forms a conductive path between the metal housing 33B and the ground portion G. This configuration makes it easier to stabilize the potential of the metal housing 33B.

The interruption unit 33A includes an igniter 33C that performs an explosion operation in response to the interruption signal B, a cutting target section 33E that is provided on a power path and interrupts the second power path 31B when the cutting target section 33E itself is cut, and a displacement section 33D that is displaced by the force generated by the explosion operation. The interruption unit 33A is a fuse device that cuts the cutting target section 33E by the displacement of the displacement section 33D that occurs in response to the explosion operation. With this configuration, the displacement section 33D is rapidly displaced by the force generated by the explosion operation of the igniter 33C, so that the second power path 31B can be interrupted in an extremely short time.

### Second Embodiment

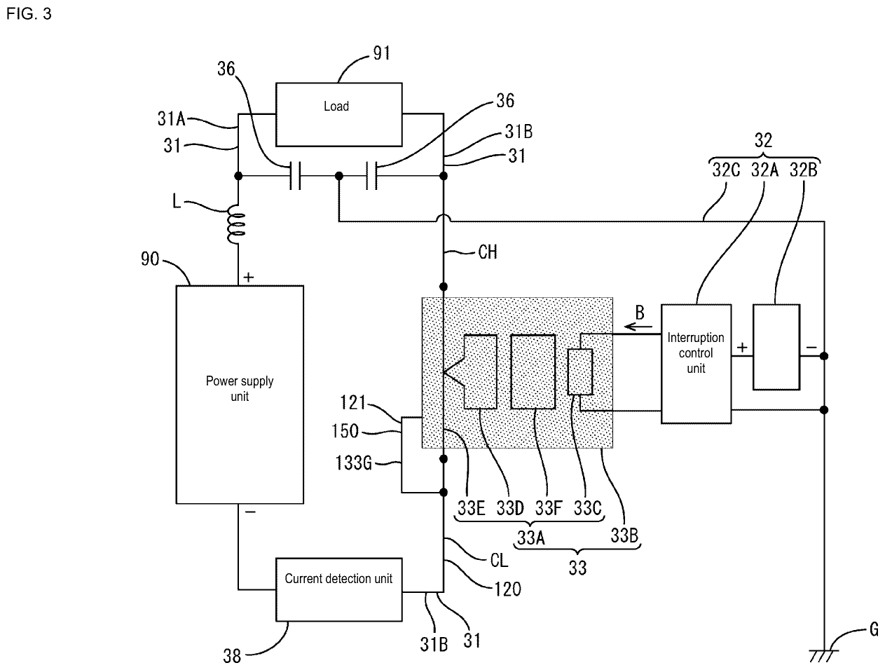

Next, a protection device 150 according to a second embodiment will be described with reference to FIG. 3. The second embodiment differs from the first embodiment in the configuration of the first circuit 31 and in that the metal housing 33B is electrically connected to a low-potential conductive path CL via a conductive portion 133G, for example. The same components as those in the first embodiment are given the same reference numerals, and the description of the same actions and effects as those in the first embodiment will be omitted.

As shown in FIG. 3, the first power path 31A has the inductance component L. The inductance component L is a parasitic component of the first power path 31A. The inductance component of the second power path 31B is extremely small compared to that of the first power path 31A, and is negligible.

A section of the second power path 31B on the load 91 side with respect to the interrupter 33 is a high-potential conductive path CH provided on the high-potential side with respect to the interrupter 33. A section of the second power path 31B on the current detection unit 38 side with respect to the interrupter 33 is a low-potential conductive path CL provided on the low-potential side with respect to the interrupter 33. That is to say, the interrupter 33 is provided so as to be able to disconnect the high-potential conductive path CH and the low-potential conductive path CL.

The protection device 150 includes a protection path section 121. The protection path section 121 includes a conductive portion 133G. The conductive portion 133G is made of a conductive metal. One end of the conductive portion 133G is electrically connected to the metal housing 33B. The other end of the conductive portion 133G is electrically connected to the low-potential conductive path CL. That is to say, the low-potential conductive path CL is included in the components of a target section 120. The conductive portion 133G is interposed between the metal housing 33B and the low-potential conductive path CL of the second power path 31B, and short-circuits the metal housing 33B and the low-potential conductive path CL of the second power path 31B. That is to say, the metal housing 33B is electrically connected to the low-potential conductive path CL of the second power path 31B via the conductive portion 133G. The conductive portion 133G is a conductive path that electrically connects the metal housing 33B and the second power path 31B (the first circuit 31).

### Operation of Interruption System

When the explosive material 33F of the interrupter 33 explodes, the displacement section 33D is rapidly displaced, and the cutting target section 33E is cut. Accordingly, a surge voltage is generated on one end side of the cutting target section 33E due to the inductance component L of the first power path 31A.

The distribution of electric charges within the metal housing 33B is biased by the surge voltage. The metal housing 33B is electrically connected to the low-potential conductive path CL of the second power path 31B by the conductive portion 133G. Therefore, even if the distribution of electric charges within the metal housing 33B is biased, electric charges are immediately exchanged with the low-potential conductive path CL, thereby preventing the surge voltage from affecting the interruption control unit 32A of the second circuit 32 via the metal housing 33B.

The power path includes the high-potential conductive path CH provided on the high-potential side with respect to the interrupter 33 and the low-potential conductive path CL provided on the low-potential side with respect to the interrupter 33. The interrupter 33 is provided so as to be able to disconnect the high-potential conductive path CH and the low-potential conductive path CL, and the target section 120 includes the low-potential conductive path CL. With this configuration, even if the distribution of electric charges within the metal housing 33B is biased by a surge voltage occurring due to the inductance component L of the first power path 31A, the bias of the electric charge distribution can be eliminated between the metal housing 33B and the low-potential conductive path CL within the first circuit 31. Therefore, it is possible to prevent the surge voltage from affecting the second circuit 32.

### Third Embodiment

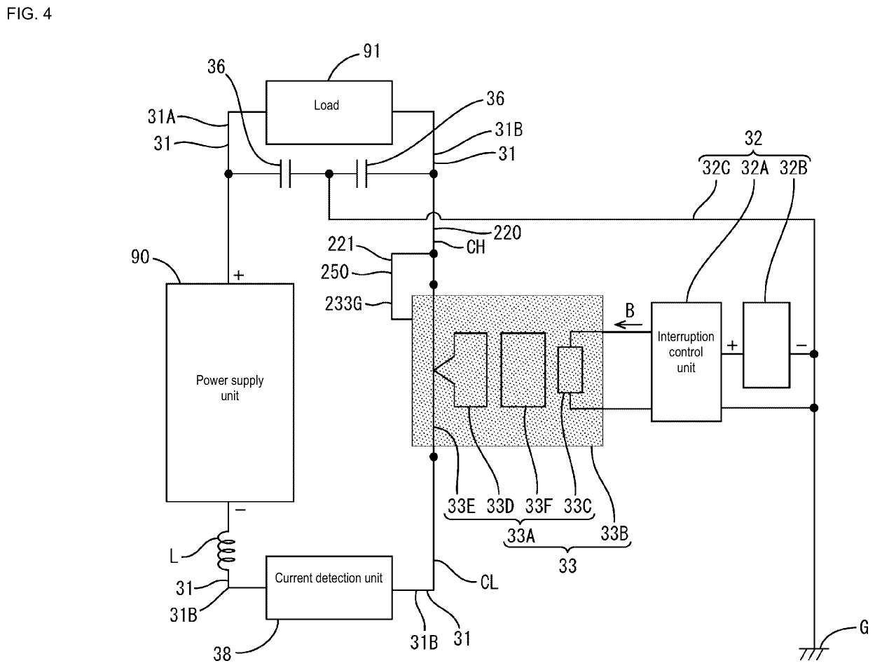

Next, a protection device 250 according to a third embodiment will be described with reference to FIG. 4. The third embodiment differs from the second embodiment in that the second power path 31B has the inductance component L, the inductance component of the first power path 31A is extremely small compared to that of the second power path 31B and is negligible, and the metal housing 33B is electrically connected to the high-potential conductive path CH via a conductive portion 233G, for example. The same components as those in the second embodiment are given the same reference numerals, and the description of the same actions and effects as those in the second embodiment will be omitted.

As shown in FIG. 4, the second power path 31B has the inductance component L. The inductance component L is a parasitic component of the second power path 31B. The inductance component of the first power path 31A is extremely small compared to that of the second power path 31B, and is negligible. The interrupter 33 is provided so as to be able to disconnect the high-potential conductive path CH and the low-potential conductive path CL.

The protection device 250 includes a protection path section 221. The protection path section 221 includes a conductive portion 233G. One end of the conductive portion 233G is electrically connected to the metal housing 33B. The other end of the conductive portion 233G is electrically connected to the high-potential conductive path CH. That is to say, the high-potential conductive path CH is included in the components of a target section 220. The conductive portion 233G is interposed between the metal housing 33B and the high-potential conductive path CH of the second power path 31B, and short-circuits the metal housing 33B and the high-potential conductive path CH of the second power path 31B. That is to say, the metal housing 33B is electrically connected to the high-potential conductive path CH of the second power path 31B via the conductive portion 233G. The conductive portion 233G is a conductive path that electrically connects the metal housing 33B and the second power path 31B (the first circuit 31).

### Operation of Interruption System

When the explosive material 33F of the interrupter 33 explodes, the displacement section 33D is rapidly displaced, and the cutting target section 33E is cut. Accordingly, a surge voltage is generated on the other end side of the cutting target section 33E due to the inductance component L of the second power path 31B.

The distribution of electric charges within the metal housing 33B is biased by the surge voltage. The metal housing 33B is electrically connected to the high-potential conductive path CH of the second power path 31B by the conductive portion 233G. Therefore, even if the distribution of electric charges within the metal housing 33B is biased, electric charges are immediately exchanged with the high-potential conductive path CH, thereby preventing the surge voltage from affecting the interruption control unit 32A of the second circuit 32 via the metal housing 33B.

The power path includes the high-potential conductive path CH provided on the high-potential side with respect to the interrupter 33 and the low-potential conductive path CL provided on the low-potential side with respect to the interrupter 33. The interrupter 33 is provided so as to be able to disconnect the high-potential conductive path CH and the low-potential conductive path CL, and the target section 220 includes the high-potential conductive path CH. With this configuration, even if the distribution of electric charges within the metal housing 33B is biased by a surge voltage occurring due to the inductance component L of the second power path 31B, the bias of the electric charge distribution can be eliminated between the metal housing 33B and the high-potential conductive path CH within the first circuit 31. Therefore, it is possible to prevent the surge voltage from affecting the second circuit 32.

### Fourth Embodiment

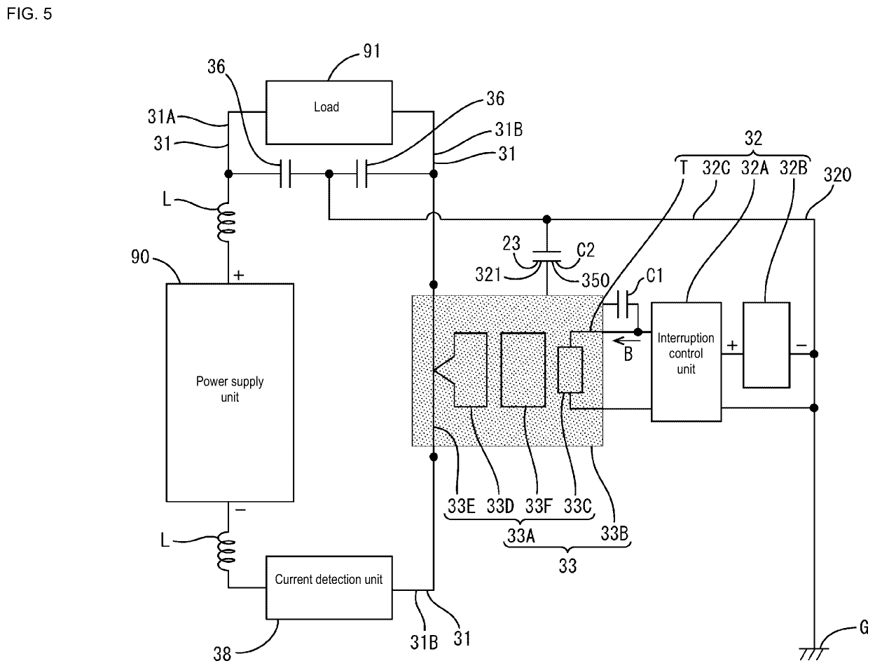

Next, a protection device 350 according to a fourth embodiment will be described with reference to FIG. 5. The fourth embodiment differs from the first to third embodiments in that a protection path section 321 of the protection device 350 includes a parasitic capacitance section 23, a first parasitic capacitance C1 is interposed between the metal housing 33B and the second circuit 32, and a second parasitic capacitance C2 larger than the first parasitic capacitance C1 is interposed between the metal housing 33B and the reference conductive path 32C, for example. The same components as those in the first to third embodiments are given the same reference numerals, and the description of the same actions and effects as those in the first to third embodiments will be omitted.

The protection device 350 includes a protection path section 321. The protection path section 321 includes a parasitic capacitance section 23. The parasitic capacitance section 23 is disposed between the metal housing 33B and the reference conductive path 32C. The parasitic capacitance section 23 is a space in which an insulating material such as synthetic resin or air is present, for example. Both may be present as the parasitic capacitance section 23. The parasitic capacitance section 23 generates a second parasitic capacitance C2 as a parasitic capacitance between the metal housing 33B and the reference conductive path 32C. The parasitic capacitance section 23 may have any structure as long as it insulates the metal housing 33B and the reference conductive path 32C from each other. The magnitude of the second parasitic capacitance C2 can be adjusted to a desired value by changing the material, size, etc. of the parasitic capacitance section 23, or by changing the distance between the metal housing 33B and the reference conductive path 32C, for example.

The second circuit 32 includes the reference conductive path 32C, which is the ground portion G, and a signal line T, which is a second conductive path different from the reference conductive path 32C. The reference conductive path 32C is included in the components of a target section 320. The signal line T has the function of outputting the interruption signal B from the interruption control unit 32A to the igniter 33C. The metal housing 33B and the signal line T (the second circuit 32) are close to each other, and as a result, the first parasitic capacitance C1, which is a parasitic capacitance, is interposed between the metal housing 33B and the signal line T. The signal line T is provided on the high-potential side with respect to the igniter 33C. When the interruption signal B is output from the interruption control unit 32A, a current flows from the signal line T to the reference conductive path 32C via the igniter 33C. The interruption signal B output by the interruption control unit 32A is a current signal that enables the igniter 33C to perform an operation to ignite the explosive material 33F, and is specifically a current equal to or greater than a predetermined value. The reference conductive path 32C is provided on the low-potential side with respect to the igniter 33C and is electrically connected to the ground portion G. The magnitude of the first parasitic capacitance C1 can be adjusted to a desired value by changing the distance between the metal housing 33B and the signal line T or by interposing a dielectric between them.

The second parasitic capacitance C2 is larger than the first parasitic capacitance C1. That is to say, the parasitic capacitance section 23 generates the second parasitic capacitance C2 that is larger than the first parasitic capacitance C1 between the metal housing 33B and the second circuit 32.

### Operation of Interruption System

When the explosive material 33F of the interrupter 33 explodes, the displacement section 33D is rapidly displaced, and the cutting target section 33E is cut. As a result, a surge voltage is generated on one end side or the other end side of the cutting target section 33E due to the inductance component L of the first circuit 31.

The distribution of electric charges within the metal housing 33B is biased by the surge voltage generated in the first circuit 31. Since the second parasitic capacitance C2 is larger than the first parasitic capacitance C1, the charges in the parasitic capacitance section 23 and the reference conductive path 32C move so as to cancel the bias of the electric charge distribution within the metal housing 33B more quickly compared to the first parasitic capacitance C1. Therefore, it is possible to make the surge voltage generated in the first circuit 31 less likely to affect the second circuit 32 via the metal housing 33B. That is to say, even if the distribution of electric charges within the metal housing 33B is biased, the second parasitic capacitance C2 can prevent the surge voltage from affecting the interruption control unit 32A of the second circuit 32. The parasitic capacitance section 23 does not directly transfer the electric charges in the metal housing 33B to the reference conductive path 32C (the target section 320). The electric changes in the parasitic capacitance section 23 move in accordance with the bias of the distribution of the electric charges within the metal housing 33B, so that the electric charges appear to move from the metal housing 33B to the reference conductive path 32C. That is to say, the parasitic capacitance section 23 appears to be a conductive path that transfers electric charges from the metal housing 33B to the reference conductive path 32C.

### Other Embodiments

The embodiments disclosed herein should be considered as illustrative in all respects and not restrictive. The scope of the present disclosure is not limited to the embodiments disclosed herein, but is indicated by the claims, and is intended to include all modifications within the meaning and scope equivalent to the claims.

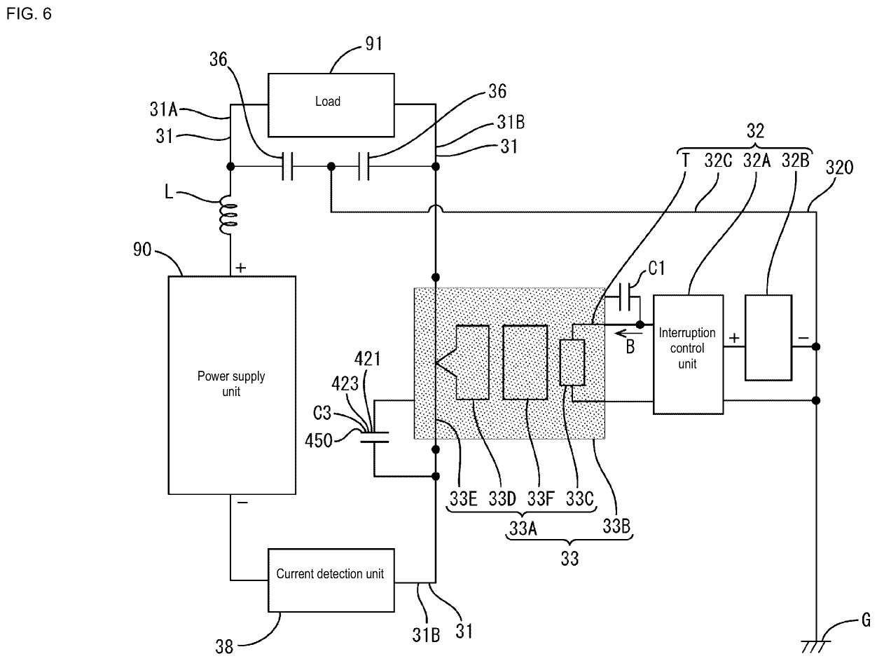

Unlike the fourth embodiment, a protection device 450 that includes a protection path section 421 may be formed as shown in FIG. 6. Specifically, a second parasitic capacitance C3, which is larger than the first parasitic capacitance C1, may be generated between the metal housing 33B and the second power path 31B by disposing a parasitic capacitance section 423, which is included in a protection path section 421, between the metal housing 33B and the second power path 31B. Note that the first power path 31A in the configuration shown in FIG. 6 has the inductance component L, which is a parasitic component. The inductance component of the second power path 31B is extremely small compared to that of the first power path 31A, and is negligible.

A comparator may be used as the current detection unit. If this is the case, the comparator outputs a predetermined high-level signal when the current value in the power path is equal to or greater than a predetermined threshold value, and outputs a predetermined low-level signal when the current value is less than the predetermined threshold value. It is also possible to employ a configuration in which a current transformer or the like is used.

Unlike the first embodiment, the metal housing may accommodate the entire interruption unit.

The conductive portion may be configured to short-circuit the target section and the metal housing or may be configured to transfer electric charges via one or more of a resistance component, a capacitance component, and an inductance component.

Both the conductive portion and the parasitic capacitance section may be present on the protection path section.

1. A protection device to be used in an interruption system comprising:
a first circuit including a power path that is a path through which electric power is transmitted;
an interrupter including an interruption unit provided so as to be able to interrupt the power path, and a metal housing accommodating at least a portion of the interruption unit; and
a second circuit that provides an interruption signal to the interruption unit,
wherein the protection device includes a protection path section including a conductive portion serving as a conductive path between a target section including either the first circuit or the ground portion and the metal housing, or a parasitic capacitance section generating a parasitic capacitance larger than a parasitic capacitance between the metal housing and the second circuit.

2. The protection device according to claim 1,
wherein the protection path section includes the conductive portion, and
the conductive portion short-circuits the metal housing and the target section.

3. The protection device according to claim 2,
wherein the target section includes the ground portion, and
the protection path section constitutes the conductive path between the metal housing and the ground portion.

4. The protection device according to claim 1,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the low-potential conductive path.

5. The protection device according to claim 1,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the high-potential conductive path.

6. The protection device according to claim 1,
wherein the second circuit includes a reference conductive path that is the ground portion, and a second conductive path that is a conductive path different from the reference conductive path,
the target section includes the reference conductive path, and
a second parasitic capacitance that is a parasitic capacitance between the metal housing and the reference conductive path is larger than a first parasitic capacitance that is a parasitic capacitance between the metal housing and the second conductive path.

7. The protection device according to claim 1, wherein the interruption unit includes an igniter that performs an explosion operation in response to the interruption signal, a cutting target section that is provided on the power path and interrupts the power path when the cutting target section itself is cut, and a displacement section that is displaced by a force generated by the explosion operation, and is a fuse device that cuts the cutting target section by displacement of the displacement section that occurs in response to the explosion operation.

8. The protection device according to claim 2,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the low-potential conductive path.

9. The protection device according to claim 3,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the low-potential conductive path.

10. The protection device according to claim 2,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the high-potential conductive path.

11. The protection device according to claim 3,
wherein the power path includes a high-potential conductive path provided on a high-potential side with respect to the interrupter and a low-potential conductive path provided on a low-potential side with respect to the interrupter,
the interrupter is provided so as to be able to disconnect the high-potential conductive path and the low-potential conductive path, and
the target section includes the high-potential conductive path.

12. The protection device according to claim 2, wherein the interruption unit includes an igniter that performs an explosion operation in response to the interruption signal, a cutting target section that is provided on the power path and interrupts the power path when the cutting target section itself is cut, and a displacement section that is displaced by a force generated by the explosion operation, and is a fuse device that cuts the cutting target section by displacement of the displacement section that occurs in response to the explosion operation.

13. The protection device according to claim 3, wherein the interruption unit includes an igniter that performs an explosion operation in response to the interruption signal, a cutting target section that is provided on the power path and interrupts the power path when the cutting target section itself is cut, and a displacement section that is displaced by a force generated by the explosion operation, and is a fuse device that cuts the cutting target section by displacement of the displacement section that occurs in response to the explosion operation.

14. The protection device according to claim 6, wherein the interruption unit includes an igniter that performs an explosion operation in response to the interruption signal, a cutting target section that is provided on the power path and interrupts the power path when the cutting target section itself is cut, and a displacement section that is displaced by a force generated by the explosion operation, and is a fuse device that cuts the cutting target section by displacement of the displacement section that occurs in response to the explosion operation.
